(19) United States
(12) Patent Application Publication
(10) Pub. No.: US 2018/0365453 A1
(43) Pub. Date: Dec. 20, 2018

(54) THEFT PROTECTION SYSTEM FOR ELECTRONIC DEVICES AND METHOD THEREFOR

(71) Applicant: ADAM HARTWAY, SCOTTSDALE, AZ (US)

(72) Inventor: ADAM HARTWAY, SCOTTSDALE, AZ (US)

(21) Appl. No.: 16/111,888

(22) Filed: Aug. 24, 2018

Related U.S. Application Data
(63) Continuation of application No. 15/469,117, filed on Mar. 24, 2017, now abandoned.

(51) Int. Cl. G06F 21/88; G06F 21/60; G06F 21/45; G06Q 20/20; G06F 21/31

(52) U.S. Cl. CPC G06F 21/88; G06F 21/602; G06F 21/31; G06Q 20/208; G06F 21/45

(57) ABSTRACT

A method for deterring theft of electronic devices comprises: generating an encrypted data package by a system server, wherein the encrypted data package contains identification codes associated with each electronic device to be protected by a manufacturer; downloading a module from the system server by the manufacturer, the module allowing the manufacturer to decrypt the encrypted data package, printing of the identification codes on one of each electronic device or packaging of each electronic device, and integrating a locking plug-in into each electronic device to be protected, the locking plug-in allowing each electronic device to have a lock mode, an unlocked mode, a delayed lock mode, and a relock mode; printing the identification codes on one of each electronic device or packaging of each electronic device; loading the locking plug-in into each electronic device to be protected so each electronic device is in the lock mode; scanning the identification codes on each electronic device or packaging of each electronic device loaded with the locking plug-in, the scanned identification codes sent to the system server; scanning a respective identification code on an electronic device or packaging to be purchased by a Point of Sale (POS) terminal of a retailer selling the electronic device to be purchased; and transmitting an unlocking code from the system server to the POS terminal.

### TECHNICAL FIELD

The present application in general relates to a theft protection system, and more specifically, to a system for deterring the unauthorized use and theft of electronic devices wherein the electronic device is programmed at the manufacturer to be in a locked state and an unlocking code is transmitted to a retailer which may be printed on a receipt and given to a customer when the electronic device is purchased, the electronic device being disabled until the unlocking code is entered.

### BACKGROUND

Shoplifting and organized crime have surpassed employee stealing as the biggest sources of retail theft. A report from the National Retail Federation published in 2014 indicated that businesses lost an estimated $44 billion in 2014 because of shoplifting, fraud or administrative error. The average shoplifting incident cost retailers $317.84.

Laptop computers, tablets, cellular phones, and other personal electronics have become a target of choice for thieves all over the country. Because they are small, valuable, can be removed quickly, are easily hidden, and there is a market for them, portable electronic devices are highly desirable by thieves. A thief can sell a stolen laptop, MP3 player, or other device to an unsuspecting used computer store or pawnshop, and easily receive up to half its value in cash. Further, stolen goods may be easily returned to the retailer where they were stolen and receive 100% of the value of the stolen goods in form or a store credit or gift card. These credits or gift cards can be sold within minutes for up to 95% of the total value.

Electronic devices may be stolen from a distribution channel, for example while they are being shipped to or between warehouses, retail outlets, wholesalers or businesses, or while they are on display in a store or in storage. Since the theft or unauthorized use of such devices in a distribution channel generally occurs prior to the purchase or delivery of the devices to the ultimate purchaser or consumer, the devices are typically stolen before a customer has had any opportunity to register for a loss prevention service. As one consequence of such theft and misuse, stores have a reduced ability to place computers and other valuable electronic devices on shelves, which limits their ability to make sales.

Theft of electronic devices may further occur during ecommerce transactions. According to package theft statistics, each year more than 23 million Americans have their packages stolen during the shipping process. That number will most likely increase as more people purchase goods online rather the traditional brick and mortar store. The number of packages stole may include theft of packages left by the front door and/or porch of the purchaser, theft of the package from the delivery vehicle, theft of the package from the delivery warehouse and the like.

Various solutions addressing the problems associated with the theft and misuse of electronic devices in a distribution channel have been proposed. However, these prior-known solutions generally fail to adequately prevent unauthorized users from using the stolen devices.

Therefore, it would be desirable to provide a system and method that overcomes the above.

### SUMMARY

In accordance with one embodiment, a method for deterring theft of electronic devices is disclosed. The method comprising: preparing a datasheet of the electronic devices to be protected by a manufacturer of the electronic devices; loading the datasheet in a system server, generating an encrypted data package by the system server, wherein the encrypted data package contains identification codes associated with each electronic device to be protected; downloading a module from the system server by the manufacturer, the module allowing the manufacturer to decrypt the encrypted data package, printing of the identification codes on one of each electronic device or packaging of each electronic device, and integrating a locking plug-in into each electronic device to be protected, the locking plug-in allowing each electronic device to have a lock mode, an unlocked mode, a delayed lock mode, and a relock mode; printing the identification codes on one of each electronic device or packaging of each electronic device; loading the locking plug-in into each electronic device to be protected so each electronic device is in the lock mode; scanning the identification codes on each electronic device or packaging of each electronic device loaded with the locking plug-in, the scanned identification codes sent to the system server; transporting each electronic device loaded with the locking plug-in to a retailer, scanning a respective identification code on an electronic device or packaging to be purchased by a Point of Sale (POS) terminal of the retailer, and transmitting an unlocking code from the system server to the POS terminal.

In accordance with one embodiment, a method for deterring theft of electronic devices is disclosed. The method comprising: generating an encrypted data package by a system server, wherein the encrypted data package contains identification codes associated with each electronic device to be protected by a manufacturer, downloading a module from the system server by the manufacturer, the module allowing the manufacturer to decrypt the encrypted data package, printing of the identification codes on one of each electronic device or packaging of each electronic device, and integrating a locking plug-in into each electronic device to be protected, the locking plug-in allowing each electronic device to have a lock mode, an unlocked mode, a delayed lock mode, and a relock mode; printing the identification codes on one of each electronic device or packaging of each electronic device; loading the locking plug-in into each electronic device to be protected so each electronic device is in the lock mode; scanning the identification codes on each electronic device or packaging of each electronic device loaded with the locking plug-in, the scanned identification codes sent to the system server, scanning a respective identification code on an electronic device or packaging to be purchased by a Point of Sale (POS) terminal of a retailer selling the electronic device to be purchased; and transmitting an unlocking code from the system server to the POS terminal

In accordance with one embodiment, a

### BRIEF DESCRIPTION OF THE DRAWINGS

The present application is further detailed with respect to the following drawings. These figures are not intended to limit the scope of the present invention but rather illustrate certain attributes thereof.

FIG. 1 is a diagram of an exemplary theft protection system according to one aspect of the present application;

FIG. 2 is a diagram showing a system server depicted in FIG. 1 in accordance with one aspect of the present application;

FIG. 3 is a flowchart depicting a theft prevention method using the system of FIG. 1 according to one aspect of the present application;

FIG. 4 is a flowchart depicting activating an electronic device locked using the system of FIG. 1 according to one aspect of the present application;

FIG. 5 is a flowchart depicting different operating modes of the electronic device according to one aspect of the present application;

FIG. 6 is an exemplary embodiment of an unlocking screen on the electronic device according to one aspect of the present application; and

FIG. 7 is a flowchart depicting a method for returning the electronic device using the system depicted in FIG. 1 according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a system for deterring the unauthorized use and theft of electronic devices wherein the electronic device is programmed at the manufacturer to be in a locked state and an unlocking code is transmitted to a retailer which may be printed on a receipt and given to a customer when the electronic device is purchased, the electronic device being disabled until the unlocking code is entered. Thus, the system and method may be effective in preventing thief of electronic devices form the point of production to the point of sale. The system and method may be effective in preventing ecommerce theft. Since the electronic device is programmed at the manufacturer to be in a locked state and the unlocking code is only available to the rightful purchasing consumer via email, text, telephone and/or web service, the incentive to steal any ecommerce package being delivered is dramatically lessened. The system and method may not require the addition of any additional parts to the electronic device being protected thereby minimizing additional cost. The system and method may have minimal impact to legitimate customers. The system and method may not require external devices to be placed on the electronic device and/or packaging, may allow the electronic devices to be displayed and not locked away thereby allowing customers to look at the electronic device, as well as for allow self-checkout, thereby improving the customer experience. The above benefits as well as other benefits of the system and method will be described in more detail below.

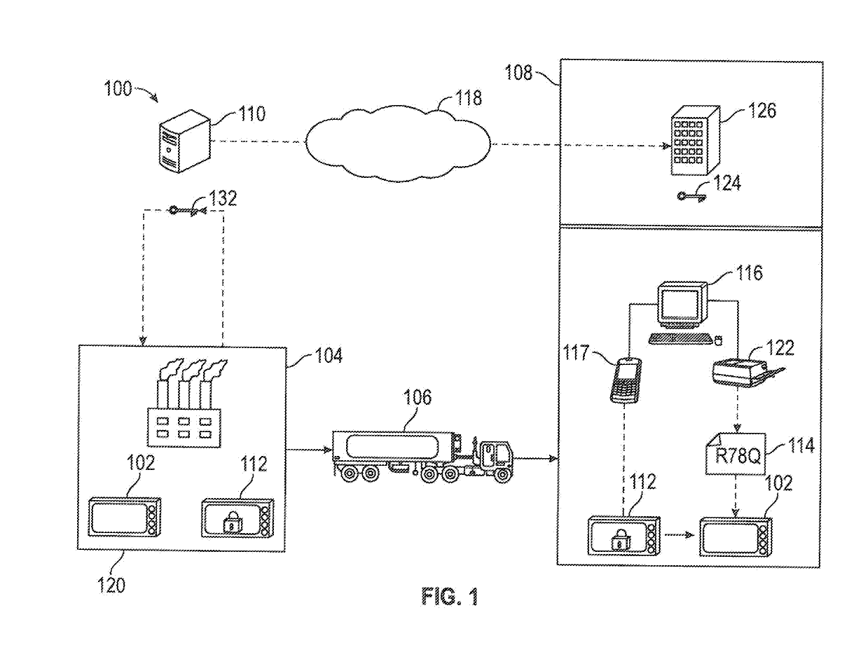

Referring now to FIG. 1, an anti-theft system 100 may be shown. The anti-theft system 100 may be used to deter the unauthorized use and theft of electronic devices 102. The system 100 may be used by manufacturers 104, distributors 106, retailers 108 as well as other parties in the distribution chain to deter theft of the electronic devices 102. The system 100 may allow manufacturers 104 to transform the electronic device 102 to a locked electronic device 112. The locked electronic-device 112 may have software programs, firmware, or other programming that prevents use of features of the locked electronic device 12 until after the locked electronic device 112 is unlocked transforming the locked electronic-device 112 to a usable electronic device 102 as will be disclosed below.

Thus, from the time the electronic device 102 is manufactured and transformed to the locked electronic device 112, through the distribution channel, and even while the locked electronic device 112 is displayed by the retailer 108, the locked electronic device 112 remains locked and unusable. In accordance with one embodiment, the locked electronic device 112 may have a display mode and/or demo mode. This may allow the retailer 108 or others to turn on the locked electronic device 112 and display a demonstration mode. However, actual operating features of the locked electronic device 112 may remained inoperable until the after the locked electronic device 112 is unlocked transforming the locked electronic-device 112 to a usable electronic device 102. The display mode may allow a display on the locked electronic device 112 to show a video and/or other demo file. The video and or demo file may be used to show and/or describe different operating features of the locked electronic device 112, allow a customer to see the resolution of the display as well as describe other aspects of the locked electronic device 112.

At or after the time of purchase, an unlocking code 114 may be generated and given to the purchaser of the locked electronic device 112. The unlocking code 114 may be entered into the locked electronic device 112 to unlock and allows functional access to the electronic device 102. Since the locked electronic-device 112 cannot be used, theft of the locked electronic device 112 may be ineffective, that is, since the electronic device 112 is inoperative there is no benefit to possessing the locked electronic device 112, and thereby, there is no motive to steal the locked electronic-device 112.

To deliver the unlocking code 114 to the purchaser of the locked electronic-device 112, a point of Sale (POS) terminal 116 of the retailer 108, a system server 110 and a network 118 may be used. The network 118 may be a local area network (LAN), a general wide area network (WAN), wireless local area network (WLAN) and/or a public network. In general a general wide area network such as the World Wide Web may be used. In general, the network 118 and the system server 110 may be independent of the manufacturer 104, distributors 106 and/or retailer 108.

To ensure privacy and to prevent unauthorized access, a secure system 100 may be needed. Encryption may be used as a mechanism to have secure communications between the point of Sale (POS) terminal 116 of the retailer 108, the system server 110 and the network 118. Two main types of encryption may be used this purpose: Wi-Fi Protected Access (WPA) and Wired Equivalent Privacy (WEP). Other security measures may also be used such as the use of security tokens. Security tokens may be used are used to prove one's identity electronically such as between the point of Sale (POS) terminal 116 of the retailer 108, the system server 110 and the network 118. The security token may be used in addition to or in place of a password.

When a customer wants to purchase the locked electronic device 112, the customer may take the locked electronic device 112 to the POS terminal 116. A scanner 117 coupled to the POS terminal 116 may be used to read a unique identification code 120 (ID code) associated with the locked electronic device 112. The ID code 120 may be used to identify the locked electronic device 112 and an unlocking security key 114 associated with the locked electronic device 112. The ID code 120 may be a one dimension barcode such as a UPC code or a two dimensional barcode such as a QR code. One-dimensional, or ID barcodes, may systematically represent data by varying the widths and spacing of parallel lines, and may be referred to as linear or one-dimensional. Two-dimensional, or 2D barcodes, systematically represent data using two-dimensional symbols and shapes. They are similar to a linear 1D barcode, but can represent more data per unit area. The ID code 120 is a unique code associated generated by the system server 110. Each ID code 120 is associated with a specific electronic device 102 and a specific unlocking code 114. The ID code 120 differs from the model numbers and product serial numbers. Model numbers and product serial numbers may not all be unique. For example, the same electronic products having the same attributes from the same manufacturer 104 may have the same model number. Thus, for example, Manufacturer ABC producing the same model of cellular phone all having the same attributes may all have the same product number. In a similar manner, product serial numbers may also not be unique. For example, different manufacturers 104 may have different methods of generating product serial numbers. Since there isn't a single source for generating the product serial numbers, different manufactures 104 may use the same product serial number

When the scanner 118 reads the ID code 120 associated with the locked electronic device 112, the POS terminal 116 may receive an unlocking code 114 based on the information from the ID code 120 scanned. The unlocking code 114 may be transmitted to the POS terminal 116 and printed on a printer 122. Depending on the embodiment, the unlocking code 114 may be automatically entered into locked electronic-device 120, printed on the receipt, displayed on a screen at the POS terminal 116, and/or transmitted to the purchaser for example by email and/or text. In any event, once the unlocking code 114 is entered into the locked electronic device 112, the locked electronic device 112 becomes unlock and allows functional access to the electronic device 102.

The ID code 114 may be sent to the POS terminal 116 in different manners. In accordance with one embodiment, when scanner 118 reads the ID code 120 associated with the locked electronic device 112, the POS terminal 116 may transmit the ID code 120 to the system server 110. The system server 110 may verify the ID code 120. Once the system server 110 verifies the ID code 120, the system server 110 may transmit the unlocking code 114 based on the information from the ID code 120 scanned back to the POS terminal 116.

In accordance with one embodiment, the ID code 120 may be an omni directional single scan databar barcode that holds 3 data elements that may be retrieved on a single scan of the scanner 118—UPC code (GTIN), application identifier (2 digit code that indicates that a data string follows, the data string called the ID code 120 for the electronic device 102 is then transmitted to the system server 110. As previously discussed, the ID code 120 is ensured to be unique as it is issued by a single source (mutually exclusive).

The retailer 108 may have a local server 126. The local server 108 may be used to connect all of the POS terminals 116 of the retailer 108 together. The local server 126 may allow for secure communication between the retailer 108 and the system server 110. The local server 126 may be used to store batch files for multiple unlocking codes 114. In this embodiment, once a retailer 108 receives a shipment of locked electronic devices 112, a batch file containing the unlocking codes 114 for each of the locked electronic devices 112 received may be sent to the retailer 108. The retailer 108 may store the batch file within the local server 126. In accordance with one embodiment, the retainer 108 may need to scan the ID codes 120 of each of the locked electronic devices 112 to verify receipt of the shipment prior to the system server 110 transmitting the batch file containing the unlocking codes 114. When a customer wishes to purchase a locked electronic device 112, the customer takes the locked electronic device 112 to the POS terminal 116. The scanner 118 may then reads the ID code 120 associated with the locked electronic device 112 being purchased. The unlocking code 114 associated with the locked electronic device 112 may be transmitted from the local server 126 to the POS terminal 116 once the local server 126 verifies the authenticity of the ID code 120.

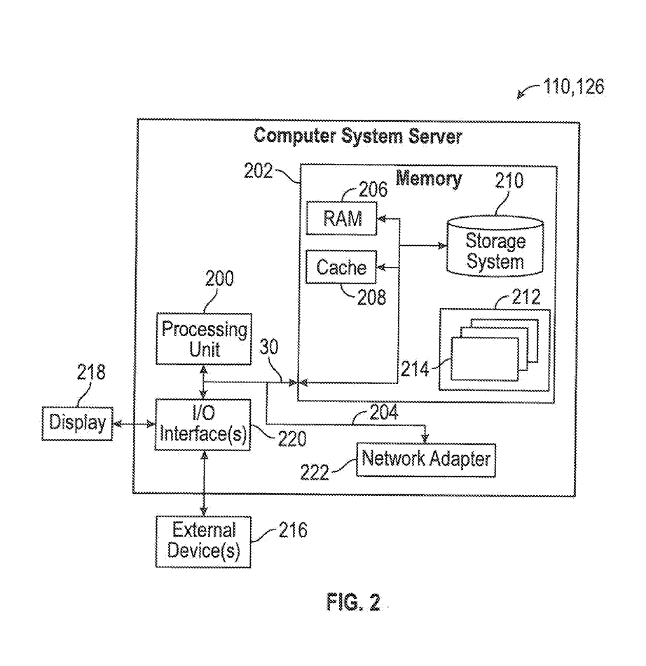

Referring now to FIG. 2, the anti-theft system 100 may use the system server 110 and the local server 126. The system server 110 and the local server 126 may (hereinafter servers 110, 126) be described in more detail in terms of the machine elements that provide functionality to the systems and methods disclosed herein. The components of the servers 110, 126 may include, but are not limited to, one or more processors or processing units 200, a system memory 202, and a system bus 204 that couples various system components including the system memory 202 to the processor 200. The servers 110, 126 may typically include a variety of computer system readable media. Such media may be chosen from any available media that is accessible by the servers 110, 126, including non-transitory, volatile and non-volatile media, removable and non-removable media. The system memory 202 could include one or more personal computing system readable media in the form of volatile memory, such as a random access memory (RAM) 206 and/or a cache memory 208. By way of example only, a storage system 210 may be provided for reading from and writing to a non-removable, non-volatile magnetic media device typically called a “hard drive”.

The system memory 202 may include at least one program product/utility 212 having a set (e.g., at least one) of program modules 214 that may be configured to carry out the functions of embodiments of the invention. The program modules 214 may include, but is not limited to, an operating system, one or more application programs, other program modules, and program data. Each of the operating systems, one or more application programs, other program modules, and program data or some combination thereof, may include an implementation of a networking environment. The program modules 214 generally carry out the functions and/or methodologies of embodiments of the invention as described herein. For example, the program module 214 in the servers 110, 126 may be configured to generate and store the unlocking codes 114 (FIG. 1) for unlocking the locked electronic-device 120 as may be disclosed below.

The servers 110, 126 may communicate with one or more external devices 216 such as a keyboard, a pointing device, a display 218, or any similar devices (e.g., network card, modern, etc.). The display 218 may be a Light Emitting Diode (LED) display, Liquid Crystal Display (LCD) display, Cathode Ray Tube (CRT) display and similar display devices. The external devices 216 may enable the servers 110, 126 to communicate with the POS terminal 116 (FIG. 1). Such communication may occur via Input/Output (I/O) interfaces 220. Alternatively, the servers 110, 126 may communicate with one or more networks 118 (FIG. 1) such as a local area network (LAN), a general wide area network (WAN), and/or a public network via a network adapter 222. The servers 110, 126 may be coupled to the one or more networks 118 via a wired or wireless connection. As depicted, the network adapter 222 may communicate with the other components via the bus 204

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 210) may be utilized. In the context of this disclosure, a computer readable storage medium may be any tangible or non-transitory medium that can contain, or store a program (for example, the program product 212) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

The system 100 may be used on any type of electronic devices 102 that may contain a processor or programmable firmware that may allow for a locked state and an unlocked state and transition between them using an unlocking code. The electronic device 102 may have a locked state, unlocked state, locking function and unlocking function. The locked state prevents use of the electronic device 102. The unlocked state allows use of the electronic device 102. The unlocking function transitions the electronic device 102 from the locked state to the unlocked state. The locking function returns the electronic device 102 to a locked state from an unlocked state.

Electronic device 102 may include any electronic-device that derive substantial benefit from software program, operating system, or other feature that responds to a computationally locked or unlocked state. Electronic device 102 may include mobile or cellular phones, for example, smart phones, portable data assistants (PDA), global positioning systems (GPS) and other handheld mobile computing devices. Electronic device 102 may include household electronics, for example, television sets, radios, stereo equipment, and other devices capable of receiving input from consumers. Electronic device 102 may include gaming consoles, for example, gaming consoles that connect to television sets, handheld gaming consoles, etc. Electronic device 102 may include digital cameras, camcorders, etc. Electronic device 102 may include other household appliances, for example, refrigerators, stoves, microwave ovens, washers and dryers, and dishwashers. The above is given as examples and should not be seen in a limiting manner. As stated above, the electronic device 102 may be any device containing a processor or programmable firmware that may allow for a locked state and an unlocked state and transition between them using an unlocking code.

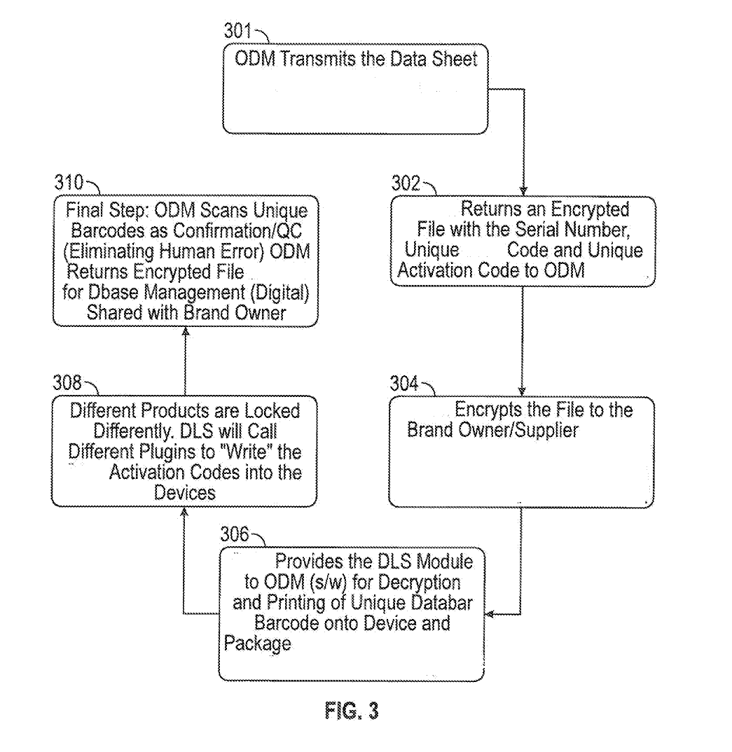

Manufacturers 104, distributors 106, and retailers 108 may interact with the system 100 in a plurality of different manners based on each of their respective needs. Referring now to FIGS. 1-3, the manufacturer 104 may interface with the system 100 in the fbllowing manner. When a manufacturer 104 wishes to use the system 100, the manufacturer 104 may contact the operators of the system 100. The operators of the system 100 may assign a specific contact person that may guide the manufacturer 104 through the process. The manufacturer 104 may compile a datasheet as shown in 301. The datasheet may list the products, model number, serial number and other identifying information related to each electronic device 102 the manufacturer 104 may wish to protect using the system 100. The datasheet may then be sent to the system server 110. In accordance with one embodiment, the datasheet may be sent to the designated contact. For example, the manufacturer 104 may email the datasheet to the system server 110 and addressed to the designated contact.

The information in the datasheet may be verified. Once verified, the information in the datasheet may be entered into the system server 110. The system server 110 may generate a unique ID number 120 for each of the electronic devices 102 the manufacturer 104 wants to protect. Thus, each electronic device 102 will have a unique ID number 120 and no ID numbers 120 are repeated. The ID number 120 may then be sent in a secure data package as shown in 302. In accordance with one embodiment, the data package may be encrypted as shown in 304. The data package may contain a serial number of the product to be protected, a unique identification code associated with the product to be protected, and an activation coda for the product to be protected. The encrypted data package may then be sent to the manufacturer 104. In accordance with one embodiment, the encrypted data package may be transmitted via email to the manufacturer 104.

In order to access the encrypted data package, the manufacturer 104 may have to enter a password or key number. In accordance with one embodiment, the manufacturer 104 may download a module from the system server 110 as shown in 306. The module may be used for a plurality of purposes. The module may allow the manufacturer 104 to decrypt the encrypted data package. Once the encrypted data package is decrypted, the unique ID codes 120 may be printed onto the electronic device 102 and/or packaging. In accordance with one embodiment, the module may allow for the digital printing of the unique ID code 120 onto the electronic device 102 and/or packaging. This serialization process allow the electronic device 102 to be identified by a unique ID code 120 which is printed on the electronic device 102 and/or packaging in the form of a one or multi-dimension barcode.

The module may also allow for the locking of the electronic device 102. The module may be used to integrate the locking software/firmware within the electronic device 102. The operators of the system 100 may work with the manufacturer 104 to determine how to integrate the locking software/firmware during the manufacturing processes with a minimal amount of intrusions. In most electronic devices 102, this may be done simultaneously with other processes during assembly of the electronic device 102. This may ensure a smooth process with minimal intrusions on the production line.

In accordance with one embodiment, the module may use HTTPS for encryption and identification and may utilize username/password authentication to allow only authorized users. HTTPS is a protocol for secure communication over a computer network which is widely used on the Internet. HTTPS consists of communication over Hypertext Transfer Protocol (HTTP) within a connection encrypted by Transport Layer Security, or its predecessor, Secure Sockets Layer.

The locking software/firmware (hereinafter locking plugin) may be installed during the manufacturing processes. However, not all electronic devices 102 may be suitable for a single locking plugin. Thus, different locking plugins maybe designed and used to lock different electronic devices 102. As stated above, the operators of the system 100 may work with the manufacturer 104 to design specific locking plugins.

The manufacturer may load the locking plugin into the electronic device 102. In accordance with one embodiment, the locking plugin may be loaded during test benching. This may ensure that the electronic device 102 is working properly prior to loading of the locking plugin. During the loading of the locking plugin, the locking functions that provide the locked and unlocked state may be provided. The locking plugin may include a device identifier, which may be used to generate a passcode on the electronic device 102. The passcode may be compared to a passcode entered pursuant to purchase of the electronic-device 102. Using automated equipment, every electronic-device may be assigned a device identifier that may be read by the locking plugin stored on the electronic device 102 that may generate an unlocking code.

Once the electronic device 102 is locked, the manufacturer 104 may use the locking module to systematically label the electronic device 102 with the unique ID code 120. As stated above, the unique ID code 120 may be printed onto the electronic device 102 and/or the packaging.

The unique ID code may then be scanned by the manufacturer 104 after the product has been manufactured and prior to shipping as shown in 310. This may be done as a quality control measure and as an indication that the electronic product 102 has been manufactured and is ready to be shipped. This information may then be encrypted and sent back to the system server 110 as verification that the unique identification code has been used and that the electronic product 102 has been produced and is ready to be shipped to the retailer 108.

When the electronic device 102 becomes a locked electronic device 112, all functions of the electronic device 102 may become disabled. In accordance with one embodiment, the locked electronic device 112 may allow for a demonstration mode as disclosed above. The demonstration mode may allow a video and/or other information to be shown on a display of the locked electronic device 112. The demonstration mode may allow a potential buyer of the locked electronic device 112 to see the resolution on the display as well as see other information provided on the video. For example, the demonstration video may explain different features of the locked electronic device 112.

The locked electronic device 112 may be sent by the distributor 106 to the retailer 108. During transport by the distributor 106, the locked electronic device 112 may remain in a locked state having operating features disabled. The locked electronic device 112 may only be unlocked after the unique identification code is scanned and verified as will be disclosed below. Thus, the system 100 may deter theft of the locked electronic device 112 as the locked electronic device 112 is unusable and may only be unlocked after the unique identification code is scanned and verified and an unlocking code transmitted to a verified buyer as disclosed below.

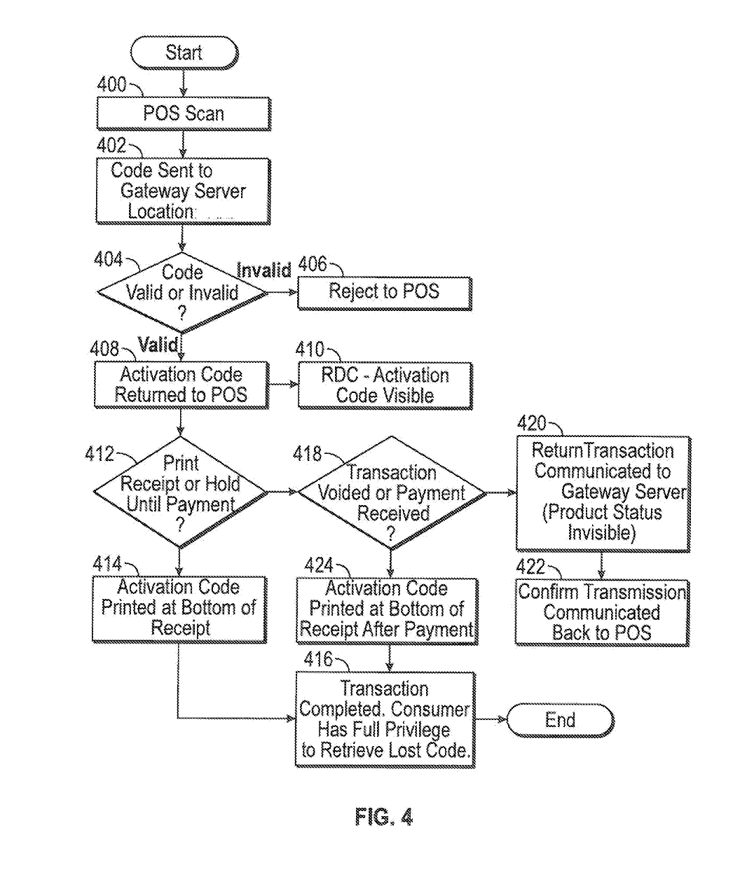

When a customer wishes to purchase the locked electronic device 112, the customer may take the locked electronic device 112 to a POS terminal 116. Referring to FIGS. 1 and 4, operation of activation of the locked electronic device 112 may be disclosed. As shown in more detail in FIG. 4, an employee of the retailer 108 may scan the unique ID code 120 generated by the system server 110 and printed on the packaging and/or the locked electronic device 112 as shown in 400. The scanner 117 coupled to the POS terminal 116 may be used to read the ID code 120 associated with the locked electronic device 112. The POS terminal 116 may send data associated with the ID code 120 to the system server 110 as shown in 402.

The system serve 110 may determine if the data associated with the ID code 120 is valid or invalid as shown in 404. If the system serve 110 determines that the data associated with the ID code 120 is invalid, the system server 110 may signal the POS terminal 116 that the transaction is invalid as shown in 406.

If the system server 110 determines that the data associated with the ID code 120 is valid, the system server 110 may signal the POS terminal 116 that the transaction is valid and the unlocking code 114 associated with the unique ID code 120 may be transmitted from the system server 110 to the POS terminal 116 as shown in 408 and then may be displayed on a display of the POS terminal as shown in 410.

In accordance with one embodiment, the determination of authenticity of the unique ID code 120 may be a multi-scan process. In this embodiment, the employee of the retailer 108 may scan both the unique ID code 120 generated by the system server 110 and printed on the packaging and/or the locked electronic device 112 as well as the product serial number. The scanner 117 coupled to the POS terminal 116 may be used to read the ID code 120 and the product serial number associated with the locked electronic device 112. The POS terminal 116 may send data associated with the ID code 120 and the serial number to the system server 110. If the system serve 110 determines that the data associated with the ID code 120 and serial product number are valid, the system server 110 may signal the POS terminal 116 that the transaction is valid and the unlocking code 114 associated with the unique ID code 120 may be transmitted from the system server 110 to the POS terminal 116. The multi-scan process may provide an additional step of verification.

Once the unlocking code 114 is transmitted from the system server 110 to the POS terminal 116, a decision may be made as to whether the unique ID code 120 should be given to the customer or held until payment is received as shown in 412. In accordance with one embodiment, the unlocking code 114 may be provided to the customer as shown in 414 once payment is received. The unlocking code 114 may be printed on a receipt, sent to the customer via Short Message Service (SMS), text, email, or by other communication mechanisms. Once the customer receives the unlocking code 114, the transaction may be completed as shown in 416.

In accordance with one embodiment, once the unlocking code 114 is transmitted from the system server 110 to the POS terminal 116, a decision may be made as to whether the payment has been received or the transaction has been voided as shown in 418. If the transaction has been voided, information relating to the voiding of the transaction may be sent to the system server 110 as shown in 420. The system server 110 may then send confirmation as shown in 422. If payment has been received, the unlocking code 114 may be provided to the customer as shown in 424. The unlocking code 114 may be printed on a receipt, sent to the customer via Short Message Service (SMS), text, email, or by other communication mechanisms. Once the customer receives the unlocking code 114 the transaction may be completed as shown in 416.

If the locked electronic device 112 is purchased through an ecommerce transaction, the verification of the unique ID code 120 and transmission of the unlocking code 114 may be done in a similar manner. In this embodiment, after the locked electronic device 112 is purchased through an ecommerce transaction, a distribution warehouse from where the locked electronic device 112 is being shipped form may scan the unique ID code 120 for verification prior to shipping. Data associated with the ID code 120 and the serial number may be sent to the system server 110. If the system serve 110 determines that the data associated with the ID code 120 and serial product number are valid, the system server 110 may signal the distribution warehouse of the authenticity. The unlocking code 114 associated with the unique ID code 120 may then be transmitted from the system server 110 and or a computer associated with the distribution warehouse to the customer. The unlocking code 114 may be sent to the customer via Short Message Service (SMS), text, email, or by other communication mechanisms.

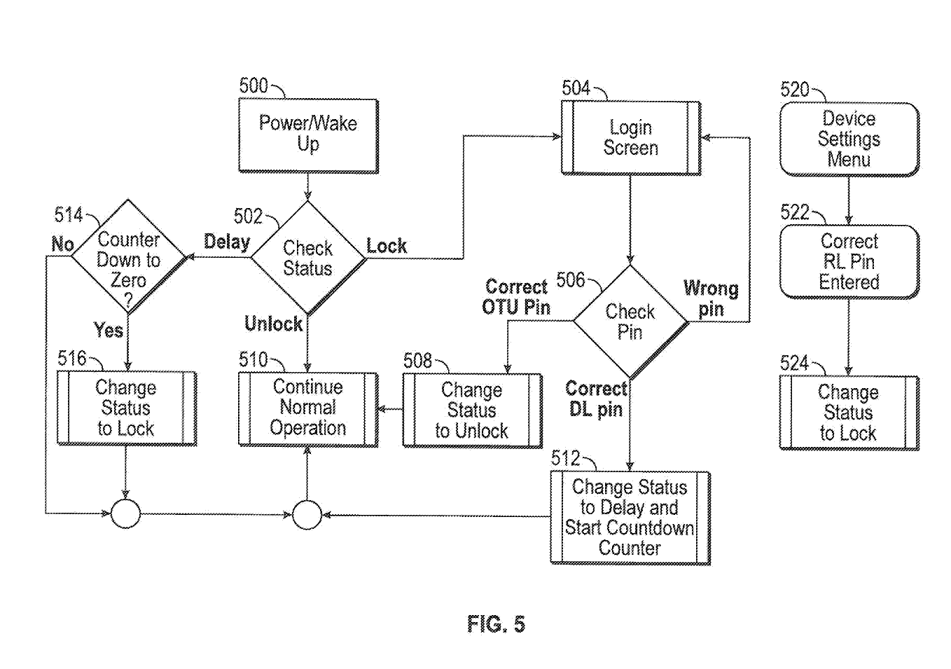

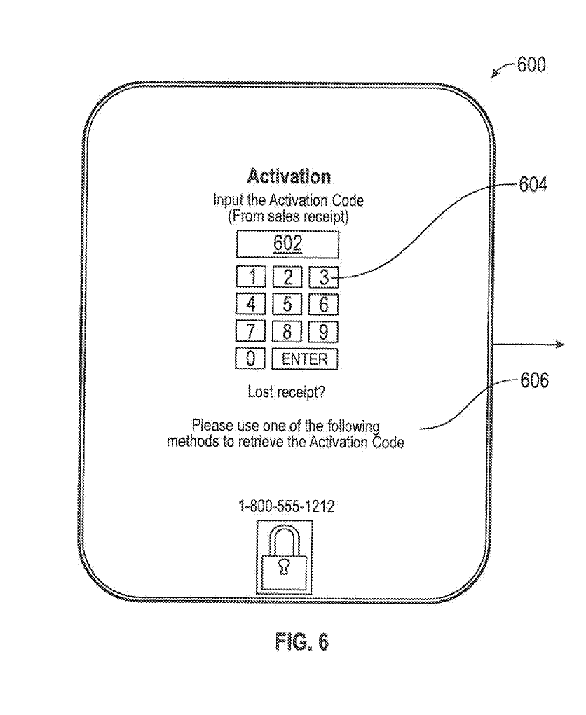

Once the customer purchases the locked electronic device 112 and receives the unlocking code 114, the customer may unlock the locked electronic device 112 to transform the locked electronic device 112 to the electronic device 102 having full functionality. Referring to FIGS. 1, 4 and 5, the customer may power up the locked electronic device 112 as shown in 500. When the locked electronic device 112 is powered on by the customer, the locked electronic device 112 may check the current status as being in either a locked or unlock state as shown in 502. If the locked electronic device 112 is in a locked state, a login screen 600 (FIG. 6) may appear on a display of the locked electronic device 112 as shown in 504. In the embodiment shown in FIG. 6, the login screen 600 may display an input area 602. The input area 602 may allow the customer to input the unlocking code 114. Different methods may be used to input the unlocking code 114 depending on the type of electronic device that is locked. If the locked electronic device 112 has an alpha-numeric keypad or other type of input device, the alpha-numeric keypad maybe used to input the unlocking code 114. If the locked electronic device 112 has a touch-sensitive display, an alpha-numeric keypad 604 may be displayed on the login screen 600 as shown in FIG. 6 used to input the unlocking code 114. For a locked electronic device 112 that may only have an alpha-numeric display such as a stereo receiver, the customer may be instructed to push certain input buttons on the locked electronic device 112 as the unlocking code 114. For example, a first input button on the far left of the locked electronic device 112 may represent the number 1, the next input button 2, and the like. The customer may then push the input buttons in an order corresponding to the unlocking code 114 to unlock the locked electronic device 112.

In accordance with one embodiment, the login screen 600 may display onscreen directions 606. The onscreen directions may direct the customer how to properly enter the unlocking code 114, contact information if the unlocking code 114 does work or is lost, as well as other information the operators of the system 100 wishes to provide. The login screen 600 may display advertisements 608 as well. The advertisements may be related to the manufacturer 104, the retailer 102, the operator of the system 100 or other parties.

Once the unlocking code 114 is entered, the locked electronic device 112 may compare the unlocking code 114 to a passcode programmed into the electronic device via the locking plugin as shown in 506. If the unlocking code 114 matches the passcode, the locked electronic device 112 changes status to an unlock mode status as shown in 508. The unlocked electronic device 102 may now be in a normal operating mode and the electronic device 102 may have full functionality as shown 510. If the unlocking code 114 does not match the passcode, the locked electronic device 112 may return back to the login screen 600 as shown in 504 and the customer may try to reenter the unlocking code 114. In accordance with one embodiment, the locking plugin may be configured to limit the number of times the customer may enter the wrong unlocking code 114. For example, if the wrong unlocking code 114 is entered more than a threshold value, for example 3 times, the locking plugin may prevent further tires. For example, the locking plugin may prevent further tries for a predetermined amount of time (i.e., 15 minutes), may disable the locked electronic device 112, and the like.

In accordance with one embodiment, the locking plugin may be designed to receive different unlocking codes 114, wherein the different locking codes 114 may perform different functions. For example, in addition to the unlocking code 114 used by the customer to unlock the locked electronic device 112, the locking plugin may be designed to receive a delay lock code. The delay lock code may be utilized by the retailer 108. When the delay lock code is entered, the locked electronic device 112 changes status to delay locked as shown in 512. This may allow the retailer to temporarily unlock the locked electronic device 112. This may allow the retailer to temporality show the functionality of the locked electronic device 112 to potential customers. When the correct delay lock code is entered, a timer within the locked electronic device 112 may start a countdown as shown in 514. As long as the timer has not reached zero, the retailer may continue to temporality show the functionality of the locked electronic device 112 as shown in 510. However, once the timer reaches zero, the demonstration ability is terminated and the locked electronic device 112 returns to a locked status as shown in 516.

The locking plugin may be designed to receive a relock code. The relock code may be utilized by the retailer 108. The relock code may be used by the retailer 108 to allow a returned electronic device 102 to be relocked and placed back into inventory. In accordance with one embodiment, in order to enter the relock code, the retailer may turn on the returned electronic device 102 and go to a device setting menu as shown in 520. The device setting menu may have a relock tab. When the retailer 102 presses the relock tab, a screen may appear to enter the relock code. The locking plugin may check to see if the relock code is correctly entered as shown in 522. If the correct relock code is entered, the status of the electronic device 102 turns to a locked electronic device 112 as shown in 524.

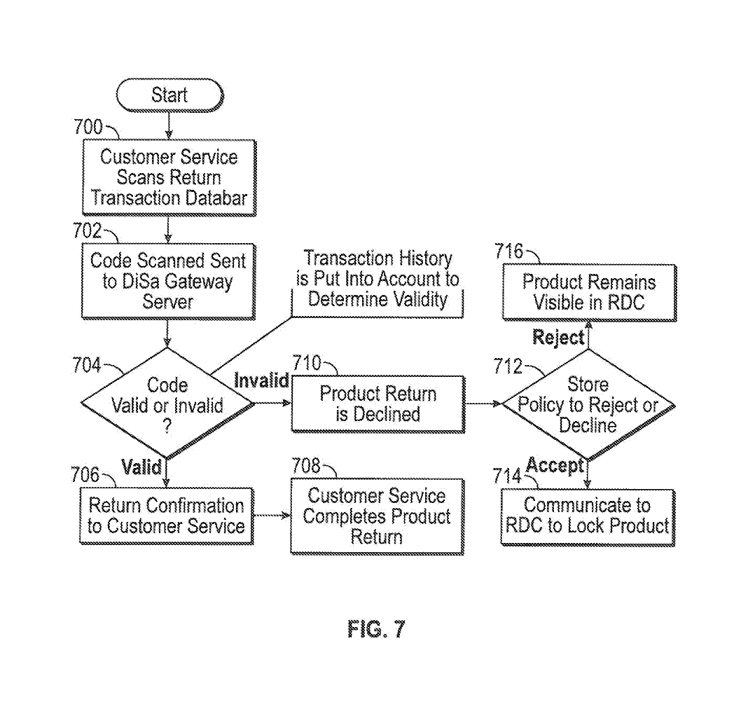

Referring to FIGS. 1 and 7, when a customer returns the electronic device 102, an employee of the retailer 102 may us a similar process with other returned items. The employee may scan a database of sales transactions as shown in 700. In accordance with one embodiment, the employee may scan a sales barcode located on the receipt with the scanner 117 on the POS terminal 116. Once the transaction is located in the local server 126 and verified, the employee may scan the unique ID code 120 printed on the electronic device 102 and/or packaging. Alternatively, the employee may just scan the unique ID code 120 as a verification of the transaction. Information from the scan of the unique ID code 120 may be sent to the system server 110 as shown in 702. The system server 110 may verify the authenticity of the unique ID code 120 as shown in 704. The system server 110 may also verify if the unique ID code 120 is associated with the electronic device 102 being returned. If the server 110 verifies the authenticity of the unique ID code 120, this information may be transmitted back to the POS terminal 166 handling the return as shown in 706. The employee may then complete the return transaction. The retailer 102 may then go through the relock process as described above. The system server 110 may then identify the re-locked electronic device 112 as a “non-sold” item.

If the server 110 determines that the unique ID code 120 is invalid, this invalidity information may be transmitted back to the POS terminal 166 handling the return as shown in 710. The retailer 102 may then decide whether to accept or reject the return transaction as shown in 712.

If the retailer 102 decides not to accept the returned electronic device 102, the retailer 102 may then communicate with the system server 110 that the retailer 102 is not accepting the returned electronic device 102 as shown in 716. If the retailer 102 decides to accept the returned electronic device 102, the retailer 102 may then communicate with the system server 110 that the retailer 102 is accepting the returned electronic device 102 and to lock the returned electronic device 102 as shown in 714.

The returned electronic device 102 may be locked in different manners. If the returned electronic device is already locked, the system server 102 may verify if the unique ID code 120 is associated with the electronic device 102 being returned. If so, the system server 102 may identify the locked electronic device 112 as a “non-sold” item and the retailer may resell the product. If the returned electronic device is unlocked and the system server 102 verifies that the unique ID code 120 is associated with the electronic device 102 being returned, the system server 102 may transmit the relock code to the retailer 102 to relock the electronic device 102. The system server 102 may then identify the locked electronic device 112 as a “non-sold” item and the retailer may resell the product. If the unique ID code 120 is not associated with the electronic device 102 being returned, the system server 102 may signal the retailer that the electronic device 102 is not part of the system 100 and not to process the return.

The system and method described above may deter the unauthorized use and theft of electronic devices 102. For example, it may work to discourage shoplifters because the packaging of the electronic device 102 may be marked to educate the shoplifter that the electronic device 102 is locked and requires unlocking after purchase. The system and method may work to discourage employee theft and inventory shrink because employees will be aware of the post purchase requirement to unlock electronic-devices.

The system and method may be low cost and may be developed with economic considerations. The system and method is based exclusively on software, there are no hadware added to the electronic devices 102, likewise there is no process, equipment or chipsets added to retail POS terminals 166. After installation of the system, there is no ongoing labor cost to the retailer 102 to maintain the theft deterring benefit. The manufacturer 104 does not need to compromise product design or final product usage, including battery life of mobile devices. For example, in some embodiments, the locking and unlocking functions may remove themselves from the electronic device 102 after purchase and the appropriate unlocking code 114 has been entered. Similarly, there is no added cost to the distributor 106.

Additionally, there may be other economic benefits provided by the system and method described above. For example, if the risk of theft is reduced, shipping costs may be reduced. For example, if the risk of theft is reduced, insurance costs may be reduced for the manufacturer 104, distributor 106, and the retailer 108. If shoplifting theft is deterred, the electronic devices 102 may be displayed more prominently and sold more readily. Deterring of shoplifting theft may reduce inventory shrink by 35%. For example, if retail theft is reduced, the electronic devices 102 may not need other types of physical security, for example locked merchandise displays, locked cages, merchandising monitoring programs, supply chain security measures, back-room security measures, plastic wraps, wireless inventory sensors, or other types of physical security. This may result in the saving on in-store fixtures. Elimination of employee theft may reduce inventory shrink by 45%. In other embodiments, by deterring fraud related to return of the electronic devices 102, inventory shrink maybe reduce another 10%. Finally, the system may displace other security measures thereby eliminating the cost of the other security measures. Elimination of physical security measures may allow new opportunity for merchandising and thereby increase sales of electronic-devices.

The foregoing description is illustrative of particular embodiments of the invention, but is not meant to be a limitation upon the practice thereof. The following claims, including all equivalents thereof, are intended to define the scope of the invention.

What is claimed is:

1. A method for deterring theft of electronic devices comprising:
preparing a datasheet of the electronic devices to be protected by a manufacturer of the electronic devices;
loading the datasheet in a system server,
generating an encrypted data package by the system server, wherein the encrypted data package contains identification codes associated with each electronic device to be protected;
downloading a module from the system server by the manufacturer, the module allowing the manufacturer to decrypt the encrypted data package, printing of the identification codes on one of each electronic device or packaging of each electronic device, and integrating a locking plug-in into each electronic device to be protected, the locking plug-in allowing each electronic device to have a lock mode, an unlocked mode, a delayed lock mode, and a relock mode;
printing the identification codes on one of each electronic device or packaging of each electronic device;
loading the locking plug-in into each electronic device to be protected so each electronic device is in the lock mode;
scanning the identification codes on each electronic device or packaging of each electronic device loaded with the locking plug-in, the scanned identification codes sent to the system server;
transporting each electronic device loaded with the locking plug-in to a retailer,
scanning a respective identification code on an electronic device or packaging to be purchased by a Point of Sale (POS) terminal of the retailer; and
transmitting an unlocking code from the system server to the POS terminal.

2. The method of claim 1, comprising verifying authenticity of the respective identification code on the electronic device or packaging to be purchased by the system server.

3. The method of claim 1, comprising providing the unlocking code to a customer purchasing the electronic device.

4. The method of claim 3, comprising providing the unlocking code to the customer purchasing the electronic device by one of printing the unlocking code on a receipt, texting the unlocking code to the customer or emailing the unlocking code to the customer.

5. The method of claim 3, comprising entering the unlocking code into the electronic device purchased to change the electronic device purchased from the locked mode to the unlocked mode.

6. The method of claim 3, comprising:
powering on the electronic device purchased;
displaying a login screen on the electronic device purchased; and
entering the unlocking code on the login screen to change the electronic device purchased from the locked mode to the unlocked mode.

7. The method of claim 6, comprising displaying a keypad on the login screen to enter the unlocking code.

8. The method of claim 1, wherein the delayed lock mode allowing the retailer to enter a delay locking code to temporary unlock an electronic device for a predetermined timeframe, wherein after the predetermined timeframe, the electronic device automatically returns to the locked mode.

9. The method of claim 1, wherein the relock mode allowing the retailer to enter a relocking code to change a purchased electronic device from the unlocked mode back to the locked mode.

10. The method of claim 9, comprising:
scanning the respective identification code on the electronic device or packaging purchased;
transmitting data from the scanned respective identification code to the system server, and
entering the relocking code by the retailer.

11. The method of claim 10, comprising identifying the electronic device purchased as a “non-sold” item in the system server.

12. A method for deterring theft of electronic devices comprising:
generating an encrypted data package by a system server, wherein the encrypted data package contains identification codes associated with each electronic device to be protected by a manufacturer;
downloading a module from the system server by the manufacturer, the module allowing the manufacturer to decrypt the encrypted data package, printing of the identification codes on one of each electronic device or packaging of each electronic device, and integrating a locking plug-in into each electronic device to be protected, the locking plug-in allowing each electronic device to have a lock mode, an unlocked mode, a delayed lock mode, and a relock mode;
printing the identification codes on one of each electronic device or packaging of each electronic device;
loading the locking plug-in into each electronic device to be protected so each electronic device is in the lock mode;
scanning the identification codes on each electronic device or packaging of each electronic device loaded with the locking plug-in, the scanned identification codes sent to the system server;
scanning a respective identification code on an electronic device or packaging to be purchased by a Point of Sale (POS) terminal of a retailer selling the electronic device to be purchased; and
transmitting an unlocking code from the system server to the POS terminal.

13. The method of claim 12, comprising verifying authenticity of the respective identification code on the electronic device or packaging to be purchased by the system server.

14. The method of claim 12, comprising providing the unlocking code to a customer purchasing the electronic device by one of printing the unlocking code on a receipt, texting the unlocking code to the customer or emailing the unlocking code to the customer.

15. The method of claim 14, comprising entering the unlocking code into the electronic device purchased to change the electronic device purchased from the locked mode to the unlocked mode.

16. The method of claim 14, comprising:
powering on the electronic device purchased;
displaying a login screen on the electronic device purchased; and
entering the unlocking code on the login screen to change the electronic device purchased from the locked mode to the unlocked mode.

17. The method of claim 12, wherein the delayed lock mode allowing the retailer to enter a delay locking code to temporary unlock an electronic device for a predetermined timeframe, wherein after the predetermined timeframe, the electronic device automatically returns to the locked mode.

18. The method of claim 12, wherein the relock mode allowing the retailer to enter a relocking code to change a purchased electronic device from the unlocked mode back to the locked mode.

19. The method of claim 18, comprising:
scanning the respective identification code on the electronic device or packaging purchased;
transmitting data from the scanned respective identification code to the system server; and
entering the relocking code by the retailer.

20. The method of claim 19, comprising identifying the electronic device purchased as a “non-sold” item in the system server.
